(19) United States
(12) Patent Application Publication
(10) Pub. No.: US 2024/0217591 A1
(43) Pub. Date: Jul. 4, 2024

(54) VEHICLE CROSSMEMBER AND FLOOR ASSEMBLY

(71) Applicant: Shape Corp., Grand Haven, MI (US)

(72) Inventors: Tomohisa Honda, Nagoya-shi (JP); Kazutoyo Fujikawa, Atsugi City (JP); Matthew Kuipers, Holland, MI (US)

(21) Appl. No.: 18/606,803

(22) Filed: Mar. 15, 2024

Related U.S. Application Data
(63) Continuation-in-part of application No. PCT/US2022/076572, filed on Sep. 16, 2022.
(60) Provisional application No. 63/245,363, filed on Sep. 17, 2021.

(51) Int. Cl. B62D 25/20

(52) U.S. Cl. CPC B62D 25/20

(57) ABSTRACT

A floor assembly for a vehicle that includes a floor panel having a metal sheet and a pair of rocker members disposed longitudinally along sides of the floor panel. A crossmember spans between the rocker members and includes a support beam that has a cross-sectional shape extending continuously along a length of the support beam. The cross-sectional shape of the crossmember includes an upper wall portion and a lower wall portion each extending along the length of the support beam. A weld is disposed at and extends through the lower wall portion to the metal sheet of the floor panel for attaching the support beam to the floor panel and together forming a reinforced structure for carrying a load path between the rocker members.

### CROSS-REFERENCE TO RELATED APPLICATIONS

This application is a continuation-in-part application of International Application No. PCT/US2022/076572, filed Sep. 16, 2022, which claims benefit and priority under 35 U.S.C. §119(e) to U.S. Provisional Patent Application No. 63/245,363, filed Sep. 17, 2021, the contents of this prior application is considered part of this application and is hereby incorporated by reference in its entirety.

### TECHNICAL FIELD

The present disclosure relates to floor structures and beams for vehicles, and more particularly to crossmember structures and related floor assemblies, sub-assemblies, and the like.

### BACKGROUND

It is generally understood that vehicle frames and body structures are designed undergo and absorb certain levels of impact forces, such as to prevent distances of inboard intrusion into the vehicle in accordance with insurance requirements and other regulatory and legal requirements. Battery storage in electric and hybrid electric vehicles make it more desirable to reduce side impact intrusion distance in order to maximize available battery storage volume, such as in the battery trays below the vehicle floor. Side impacts to a vehicle are commonly tested with side pole impact testing, which direct significant side impact forces to the vehicle. Vehicle frames primarily absorb these side impacts at the rocker sections that run longitudinally along the lower outboard portions of the vehicle frame.

### SUMMARY

One aspect of the disclosure provides a vehicle floor assembly that includes a floor panel and a support beam disposed at and extending over an upper surface of the floor panel, such as laterally across the vehicle floor. The support beam includes a cross-sectional shape that extends continuously along a linear length of the support beam. The cross-sectional shape of the support beam includes a lower wall portion that is welded to the metal sheet of the floor panel to form a tubular shape that at least partially encloses a hollow area that extends the linear length of the support beam. The welding may enclose a tubular shape formed by the crossmember alone or formed by the crossmember in combination with the floor panel. The enclosed tubular structure formed by the welding of the crossmember to the floor panel increases rigidity and bending strength of the crossmember, such as to allow the crossmember to be formed with lighter and higher gauge metal sheet material.

Implementations of the disclosure may include one or more of the following optional features. In some examples, the support beam includes a metal sheet that is formed to have at least one tubular section extending along the linear length of the support beam. The metal sheet of the support beam may be a martensitic steel with a tensile strength of at least 980 MPa, such as a tensile strength of at least 1,500 MPa.

In some implementations, the support beam includes a metal sheet that is roll formed to have a pair of adjacent tubular members that are divided by the lower wall portion of the support beam. The pair of adjacent tubular members may be disposed horizontally adjacent to each other when spanning across the vehicle floor. In some examples, the floor panel includes a ridge protruding upward from a planar extent of the floor panel, such that the lower wall portion may be welded to the ridge to arrange the pair of adjacent tubular members on opposing sides of the ridge.

Another aspect of the disclosure provides a floor assembly for a vehicle that includes a crossmember. The vehicle floor assembly includes a floor panel having a metal sheet and a pair of rocker members disposed longitudinally along sides of the floor panel. A crossmember spans between the rocker members and includes a tubular beam that has a cross-sectional shape extending continuously along a length of the tubular beam. The cross-sectional shape of the crossmember includes an enclosed tubular shape extending along the length and an upper wall portion and a lower wall portion each extending alongside the tubular shape. A weld is disposed at the upper wall portion and extends through the lower wall portion to the metal sheet of the floor panel for attaching the crossmember to the floor panel.

Implementations of the disclosure may include one or more of the following optional features. In some examples, the crossmember extends laterally across the vehicle floor to carry a load path between the pair of rocker members. In some implementations, the crossmember includes a pair of tubular members that are divided by the upper and lower wall portions. In some examples, a bottom surface of the crossmember contacts an upper surface of the metal sheet along the length and of the tubular beam. The crossmember may be formed from a metal sheet with a tensile strength of at least 980 MPa, such as at least 1,500 MPa.

In some implementations, the floor panel includes a ridge protruding upward from a planar extent of the floor panel, where a lower wall portion of the crossmember is welded to the ridge, such as to arrange a pair of adjacent tubular members of the crossmember on opposing sides of the ridge. In some examples the metal sheet of the floor panel includes a martensitic steel with stamped stiffening features.

In some examples, the vehicle floor assembly includes a second crossmember attached and spanning between the pair of rocker members at a longitudinally spaced distance from the other crossmember. The crossmembers may be used and configured to support a seat assembly that is attached to crossmembers.

The details of one or more implementations of the disclosure are set forth in the accompanying drawings and the description below. Other aspects, advantages, purposes, and features will be apparent upon review of the following specification in conjunction with the drawings.

### BRIEF DESCRIPTION OF THE DRAWINGS

FIG. 1 is a side elevation view of a vehicle showing a floor assembly.

FIG. 2 is an upper perspective view of the floor assembly shown in FIG. 1.

FIG. 3 is a top plan view of the floor assembly shown in FIG. 1.

FIG. 4 is a side elevation view of the floor assembly shown in FIG. 1.

FIG. 5 is a cross-sectional view of a crossmember taken at line V-V in FIG. 3.

FIG. 6 is a cross-sectional view of an additional example of a crossmember.

FIG. 7 is a cross-sectional view of another crossmember.

FIG. 8 is a chart showing information related to the crossmembers in FIGS. 6 and 7.

FIGS. 9-14 are cross-sectional views of further crossmember examples.

Like reference numerals indicate like parts throughout the drawings.

### DETAILED DESCRIPTION

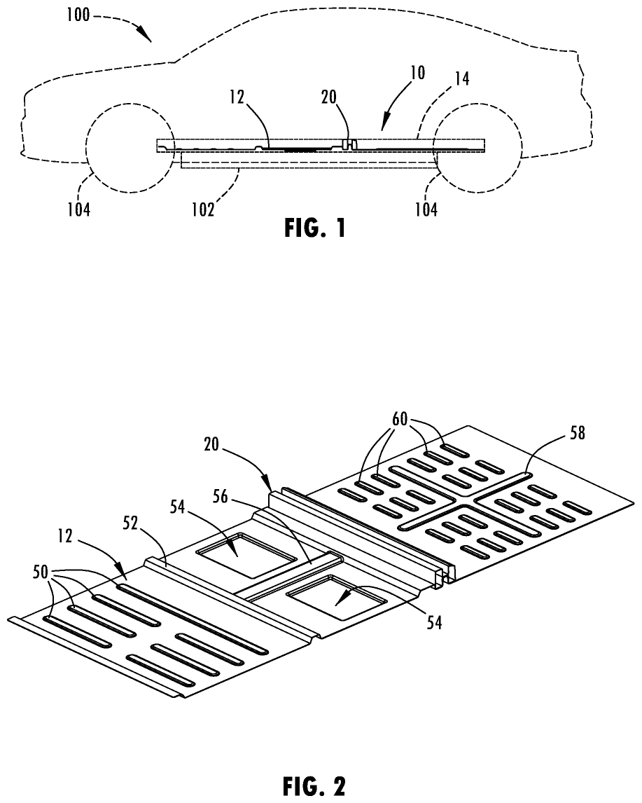

Referring now to the drawings and the illustrative examples depicted therein, a floor assembly 10 for a vehicle 100, such as shown in FIG. 1, has a floor panel 12 and a pair of rocker sections 14 disposed longitudinally along sides of the floor panel 12. The floor assembly 10 or vehicle structure may also include stamped features formed in the floor panel 12 between the longitudinal members or rocker sections 14. In additional examples, a central tunnel may protrude longitudinally along a center of the floor, such as for spanning over or partially housing vehicle drive train and exhaust system components of an internal combustion engine (ICE) vehicle. It is also contemplated that the central tunnel may house or partially enclose wire harnesses, coolant lines, or electrical components, such as those related for an electric vehicle.

As shown in the example provided in FIG. 1, the vehicle 100 may include a battery tray 102 mounted generally inboard from outer sills of the rocker sections 14 and below the floor panel 12 of the floor assembly 10. The battery tray 102 encloses a battery or batteries that are at least partially used to operate a propulsion system of the vehicle 100, such as a traction battery or battery modules or the like. The battery tray 102 may be generally between the front and rear wheels 104 of the vehicle 100 to distribute the battery weight and establish a low center of gravity for the vehicle. The vehicle for purposes of the disclosure may be any type of land motor vehicle, such as a car, truck, bus, van, sport utility vehicle, or the like, including those used for passenger travel, cargo shipping, or any other personal, governmental, or commercial purposes.

The floor assembly 10, such as shown in FIGS. 2-4, includes at least one support beam, such as shown as a crossmember 20. It is contemplated that in other examples, additional crossmembers may be provided between the rocker sections, with or without the crossmember attachment configuration and structure shown in FIGS. 2-14. The crossmember 20 is disposed at and extends over an upper surface of the floor panel 12, such as shown spanning laterally across the top side of the vehicle floor panel 12. The crossmember 20 includes a tubular beam that has a cross-sectional shape extending continuously along the length of the tubular beam, such that the cross-sectional shape of one or more of the tubular formations integrated in the tubular beam are provided along the linear length of the crossmember as shown in FIG. 2.

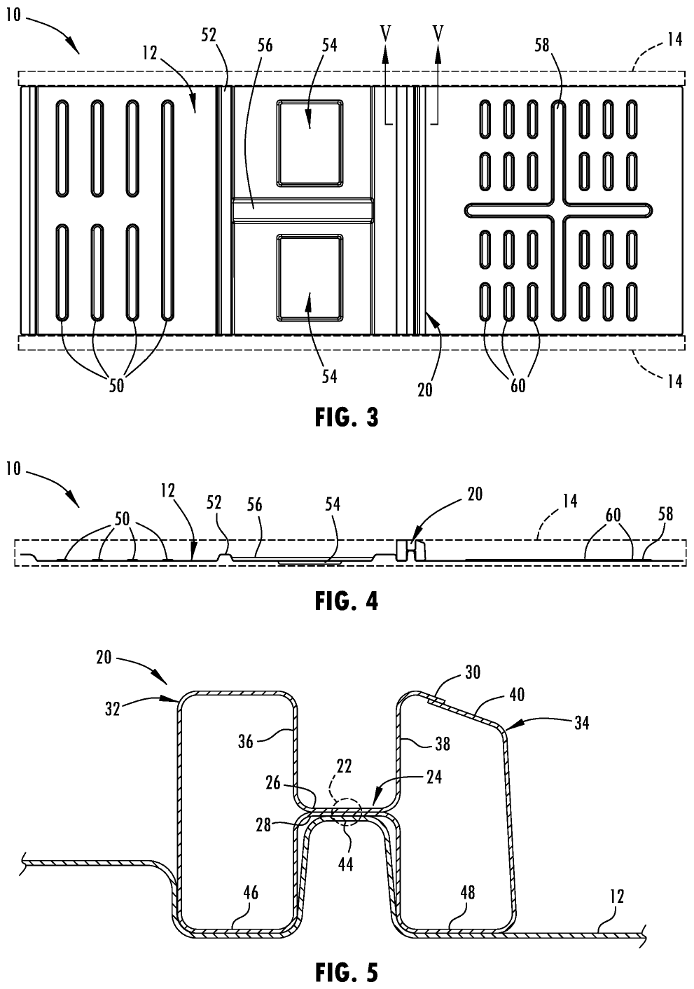

As shown in FIG. 3, the crossmember 20 is coupled to and spans between the rocker sections 14, such as to define a lateral load path between the rocker sections 14 for transmitting side impact loads or forces laterally across the floor panel 12. By doing so, inboard deformation from side impacts is reduced, such as to prevent impact intrusion interference with the battery tray. The rocker sections 14 are shown as exemplary configurations, which may be implemented as inner and outer sills, panels, or other longitudinal frame components or portions thereof. The crossmember 20 may couple with the rocker sections directly or indirectly, such as with the use of direct welding, adhesive, fasteners, and/or brackets or the like. For example, the crossmember may include a pair of mounting brackets that are attached between the opposing ends of the tubular beam and inboard surfaces of the rocker sections. Such mounting brackets may be formed or stamped with different shapes for configurations, such as to mount along sides or span over the crossmember.

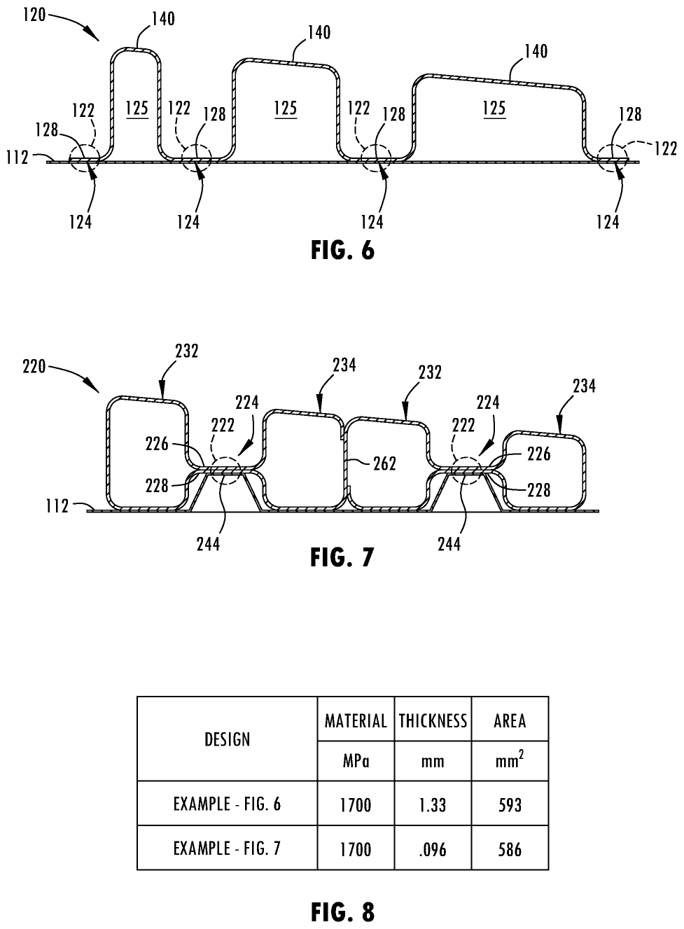

As shown in FIGS. 2-7, the crossmember 20 is disposed over the floor panel 12 with a bottom surface of the crossmember 20 supported on the upper surface of floor panel 12. The crossmember 20 is attached to the metal sheet of the floor panel 12 with welding 22 between a wall portion of the crossmember 20 and the floor panel 12. The welding 22 encloses a tubular shape formed by the crossmember 20 alone, such as shown in FIG. 5, or formed by the crossmember 120 in combination with the floor panel 112, such as shown in FIG. 6. The enclosed tubular structure formed by the welding 22 of the crossmember 20 to the floor panel 12 increases rigidity and bending strength of the crossmember, such as to allow the crossmember to be formed with lighter and higher gauge metal sheet material. Also, the welding of the crossmember to the floor panel can provide a structural or support beam configured to mounting a seat assembly to the vehicle floor.

As shown in FIG. 5, the cross-sectional shape of the crossmember 20 includes an overlapping wall region 24 defined by an upper wall portion 26 disposed in close contact with a lower wall portion 28 along the length of the crossmember 20. At the overlapping region 24, the upper wall portion 26 and the lower wall portion 28 have a planar shape and are disposed in abutting engagement with each other. It is understood that direct contact may not be provided or maintained along the entire length due to manufacturing tolerances. Prior to its assembly with the floor panel 12, the overlapping wall region 24 of the crossmember 20 does not have a weld between the upper and lower wall portions 26, 28. However, in some examples, it is contemplated that some welds may be intermittently disposed along the overlapping region, so long as there is sufficient area without welds to allow the welding to be formed between the overlapping region and the floor panel. Upon assembly with the floor panel 12, the overlapping wall region 24 is welded to the metal sheet of the floor panel 12 to close any tolerance gap between the upper and lower wall portions and enclose the hollow area or areas adjacent to the overlapping region. The weld joint 22 at the overlapping region 24 may be formed with intermittent or continuous laser welding or gas metal arc welding.

As also shown in FIG. 5, the crossmember 20 includes a metal sheet that is roll formed to the cross-sectional shape that is illustrated and the edges of the metal sheet are welded at a lap joint 30. The cross-sectional shape has a pair of adjacent tubular sections or members, a front tubular section 32 and a rear tubular section 34, that are divided by the overlapping region 24 formed by the upper and lower wall portions 26, 28. The front tubular section 32 includes a generally rectangular shape with the rear wall portion 36 integrally connecting to the upper and lower wall portions 26, 28 that form the overlapping region. The overlapping region 24 integrally transitions rearward with the upper wall portion 26 having a bend to transition upward and the lower wall portion 28 having a bend to transition downward to form the front wall portion 38 of the rear tubular section 34. The cross-sectional shape of the rear tubular section 34 has an approximately rectangular shape with the top and rear wall portions 40, 42 angled rearward. As shown in FIG. 5, the lap joint 30 is formed at a top wall portion 32 of the rear tubular section 34 of the crossmember 20. In additional examples, the lap weld may be located at different areas of the cross-sectional shape. It is understood that additional examples may have various differently shaped tubular sections or members, such as to accommodate desired mounting arrangements for different seat assemblies, interior counsels, or the like.

The adjacent tubular sections 32, 34, such as shown in FIGS. 4 and 5, are disposed horizontally adjacent to each other when spanning across the vehicle floor. The floor panel 12 includes a ridge 44 protruding upward from a planar extent of the floor panel 12, such that the lower wall portion 28 at the overlapping region 24 of the crossmember 20 contacts the ridge 44 to arrange the pair of adjacent tubular members 32, 34 on opposing sides of the ridge 44, while simultaneously placing the bottom wall portions 46, 48 of the front and rear tubular sections 32, 34 in connect with the planar portions of floor panel 12 on respective front and rear sides of the ridge 44. With the overlapping region 24 in contact with the ridge 44, the welding fuses the upper wall portion 26, the lower wall portion 28, and the metal sheet of the floor panel 12 together at the weld joint 22. By joining the upper and lower wall portions 26, 28 together at the weld joint 22, the separate tubular shapes of the front and rear tubular members 32, 34 are enclosed along the linear length of the crossmember 22.

The floor panel 12 includes a steel sheet with stamped stiffening features, such as shown in FIG. 3. The stamped stiffening features include the ridge 44 engaged by the crossmember welding 22 as well as additional features. The front area of the floor panel 12 includes a series of lateral ribs 50 that protrude upward to stiffen the foot wells at the forward area of the floor panel 12. Also, another lateral ridge 52 is disposed rearward of the foot wells to form a structure for mounting a front portion of the seat assemblies. There are two square recessed areas 54 are formed between the lateral ridges 52, 44 for providing space for seat assembly components, wire harnesses, and air circulation below the respective seat assemblies. Also, a longitudinal ridge 56 is formed between the front ridge 52 and the crossmember 20 to provide additional longitudinal stiffness for supporting the seat assemblies. A raised plus-shaped rib 58 and surrounding raised pill-shaped ribs 60 are provided rearward the crossmember, such to stiffen the floor panel for a rear seat area or a cargo area of the vehicle. The metal sheet of the floor panel may be a martensitic steel, such as with a thickness of 2 mm and a tensile strength of at least 980 MPa, and in some examples the floor panel may be divided into sections or separate floor pans.

In some examples, the vehicle floor assembly may includes a second crossmember attached and spanning between the pair of rocker members at a longitudinally spaced distance from the other crossmember. For example, the front ridge may include a crossmember attached along it. In this case the front and rear crossmembers may be used and configured to support front and rear mounting locations of a seat assembly that is attached to crossmembers.

As shown in FIG. 6, an additional example of crossmember 120 has a lower wall portion 128 that is welded to the floor panel 112 in at least at two locations to enclose a hollow tubular area defined between the crossmember 120 and the floor panel 112. The cross-sectional shape of the crossmember 120 shown in FIG. 6 includes four overlapping regions 124 defined by the lower wall portion 128 disposed in close contact with the floor panel 112. At the overlapping regions 124, the lower wall portion 128 and the floor panel 112 have a planar shape and are disposed in abutting engagement with each other. Upon assembly of the crossmember 120 with the floor panel 112, the overlapping region 124 is welded to enclose the hollow areas 125 adjacent to the overlapping regions 124. The welding 122 at the overlapping region 124 may be formed with intermittent or continuous laser welding or gas metal arc welding.

As also shown in FIG. 6, the crossmember 120 includes a metal sheet that is roll formed to the open cross-sectional shape that is illustrated. The cross-sectional shape has three adjacent hat-shaped sections that are divided by the overlapping regions 124 formed between the lower wall portions 128 and the floor panel 112. The hat-shaped sections have varied widths and heights to provide the top wall portions 140 of each resulting tubular section with a desired mounting surface. The metal sheet of the crossmember may be a martensitic steel with a tensile strength of at least 980 MPa, such as at least 1,500 MPa, such as 1,700 MPa as noted in FIG. 8.

Another example of a floor assembly 210 is shown in FIG. 7, where the crossmember has four tubular sections formed as a unitary piece from a metal sheet that is bent or otherwise deformed, such as via roll forming or progressive stamping. The tubular sections of the crossmember of FIG. 7 are divided by a common center wall 262 that separates a pair of adjacent tubular sections 232, 234 disposed horizontally adjacent (side-by-side) to each other when spanning across the vehicle floor 212. The metal sheet of the crossmember is roll formed about the common center wall, so as to bend the sheet in the same rotational direction about the center wall and place the edges in contact with the opposing ends of the center wall to be welded to the center wall. The front and rear pairs of tubular sections 232, 234 are each formed by bending the top and bottom walls vertically inward to provide central overlapping wall regions 224. The overlapping wall regions 224 are each defined by an upper wall portion 226 disposed in close contact with a lower wall portion 228 along the length of the crossmember 220. At the overlapping region, the upper wall portion and the lower wall portion have a planar shape and are disposed in abutting engagement with each other. It is understood that direct contact may not be provided or maintained along the entire length due to manufacturing tolerances.

As further shown in FIG. 7, the floor panel 212 includes two ridges 244 that protrude upward from a planar extent of the floor panel 212, such that the lower wall portions 228 at each of the overlapping regions contact the ridge 244 to arrange the pair of adjacent tubular sections 232, 234 on opposing sides of the ridges 244. The tubular sections 232, 234 simultaneously have the bottom wall portions of the front and rear tubular sections 232, 234 in connect with the portions of floor panel on respective front and rear sides of the ridges. With the overlapping region in contact with the ridge 244, the welding 222 is formed (with intermittent or continuous laser welding or gas metal arc welding) to fuse the upper wall portion 226, the lower wall portion 228, and the metal sheet of the floor panel 212 together at the weld joint 222. By joining the upper and lower wall portions 226, 228 together at the weld joint 222, the separate tubular shapes of the front and rear tubular members 232, 234 are enclosed along the linear length of the crossmember 220. Also, upon assembly with the floor panel 212, the overlapping wall region 224 is welded to the metal sheet of the floor panel 212 to close any tolerance gap between the upper and lower wall portions and enclose the hollow areas adjacent to the overlapping region. By forming the two weld joints 222 and the resulting four tubular section shown in FIG. 7, the strength of the crossmember and floor panels is substantially increased, such that the thickness of the metal sheet of the cross member can be reduced, such as to approximately 0.96 mm (FIG. 8) to reduce weight of the crossmember while maintaining the structural performance. Also, the metal sheet of the crossmember may be a martensitic steel with a tensile strength of at least 980 MPa, such as at least 1,500 MPa, such as 1,700 MPa as noted in FIG. 8.

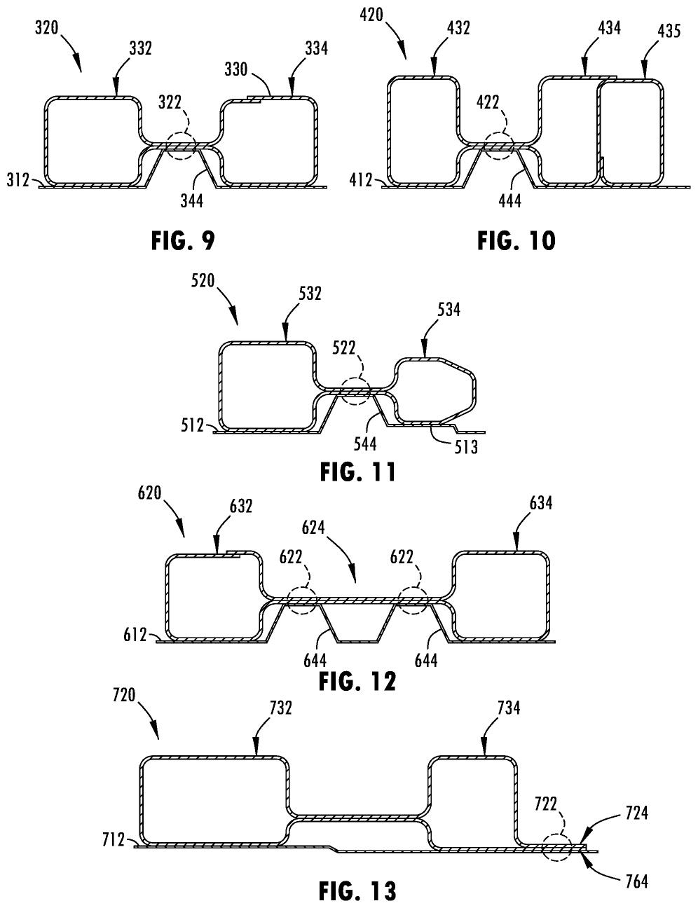

Referring now to FIGS. 9-14, additional examples of crossmember and floor panel configurations are provided with different overlapping regions and weld joints. Like reference numbers are provided at like features to those described above. As shown in FIG. 9, the tubular sections 332, 334 are shown as being substantially mirror images across the weld joint 322 at the overlapping region, aside from the lap welded seam 330 at the top wall portion of the rear tubular section 334. As shown in FIG. 10, the crossmember 420 includes two tubular sections 434, 435 rearward the overlapping region 424 welded to the ridge 444. As shown in FIG. 11, the floor panel 512 includes a rear stepped area 513 with a raised height from the floor panel forward the ridge 544, such that the rear tubular section 534 of the crossmember 520 has a shorter height below the overlapping region so that the stepped area 513 of the floor panel supports the rear tubular section 534. As shown in FIG. 12, the overlapping region 624 may be attached with two weld joints 622 to two ridges 644. Further, as shown in FIG. 13, an overlapping region 724 is provide at the edge portions 764 of the metal sheet of the crossmember 720.

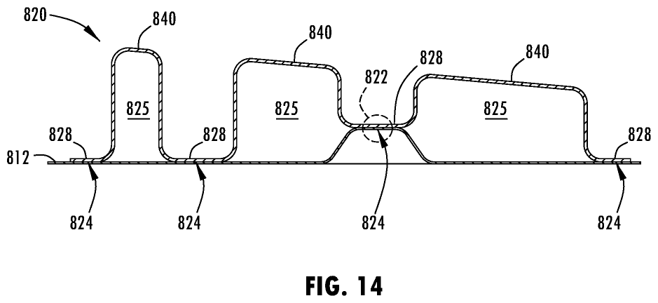

As shown in FIG. 14, similar to the example shown in FIG. 6, an additional example of a crossmember 820, referred more generally to a support beam, includes a metal sheet that is roll formed to provide an open cross-sectional shape with three adjacent and interconnected hat-shaped sections. The hat-shaped sections have varied widths and heights to provide the top wall portions 840 of each resulting tubular section with a desired mounting surface. The hat-shaped sections are defined by interconnected upper wall portions 840, upright wall portions, and lower wall portions 828. The lower wall portions 828 contact the floor panel 812 to enclose a hollow tubular areas 825 defined between the crossmember 820 and the floor panel 812. The contact with the floor panel provide the overlapping regions 824 formed between the lower wall portions 828 and the floor panel 812. At the overlapping regions 124, the lower wall portion 128 and the floor panel 112 have a planar shape and are disposed in abutting contact with each other.

The crossmember 820 shown in FIG. 14 is welded to the floor panel 812 in a single location. The floor panel 812 has a ridge that extends laterally along a lateral section of the floor panel 812 and protrudes upward from a planar extent of the floor panel 812. As shown in FIG. 14, one of the interior overlapping regions 824 has a weld joint 822 disposed at and extending through the lower wall portions 828 and into the ridge to attach the crossmember 820 to the floor panel 812. This welded attachment at the ridge and lower wall portion form a combined structure that is configured to carry a load path laterally between the pair of rocker members.

The metal sheet of the crossmember 820 may be a martensitic steel with a tensile strength of at least 980 MPa, such as at least 1,500 MPa, such as 1,700 MPa. Upon assembly of the crossmember 820 with the floor panel 812, the overlapping region 824 with the ridge is welded to the floor panel 812 at the weld joint 822. The weld joint 822 at the overlapping region 824 may be formed with intermittent or continuous laser welding or gas metal arc welding.

The crossmember may be made from a sheet of steel material having a thickness of 0.8 mm to 1.4 mm or approximately between 1 mm and 1.5 mm. Also, the sheet may have a tensile strength of about 800 to 2000 MPa (i.e. about 120 to 290 ksi), such as at least 980 MPa or at least 1,500 MPa. In additional implementations the reinforcement beam can be made of different materials, including AHSS (Advanced High Strength Steels) and it can be made from a sheet having a thickness of about 0.8 mm to 3.0 mm thick. Alternatively, the metal sheet may be a high strength aluminum sheet.

Also, the crossmembers may include mounting features at desirable locations for mounting a seat assembly or other vehicle components or sub-assemblies. The mounting features may include holes or attachment features (e.g., SPAC nuts, riv nuts, or the like) at selection locations on the top walls to provide similar attachment locations.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

Also for purposes of this disclosure, the terms “approximately,” “about,” and “substantially” as used herein represent an amount close to the stated amount that still performs a desired function or achieves a desired result. For example, the terms “approximately,” “about,” and “substantially” mayrefer to an amount that is within less than 5% of, within less than 1% of, within less than 0.1% of, and within less than 0.01% of a stated amount. Further, it should be understood that any directions or reference frames in the preceding description are merely relative directions or movements. For example, the terms “upper,” “lower,” “right,” “left,” “rear,” “front,” “vertical,” “horizontal,” “inboard,” “outboard” and derivatives thereof shall relate to the orientation shown in FIG. 1. However, it is to be understood that various alternative orientations may be provided, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A vehicle floor assembly comprising:
a floor panel comprising a metal sheet that forms a lateral section of the floor panel; and
a support beam disposed at and extending over an upper surface of the metal sheet,
wherein the support beam comprises a cross-sectional shape that extends continuously along a linear length of the support beam,
wherein the cross-sectional shape of the support beam includes a portion that is welded to the lateral section of the metal sheet of the floor panel, and
wherein the support beam or a combination of the support beam and the floor panel form a tubular shape that encloses a hollow area that extends the linear length of the support beam.

2. The vehicle floor assembly of claim 1, further comprising a pair of rocker sections extending longitudinally along outboard edges of the floor panel, wherein the support beam extends laterally across the floor panel between the pair of rocker sections, and wherein the support beam defines a lateral load path between the pair of rocker sections.

3. The vehicle floor assembly of claim 1, wherein the support beam comprises a sheet formed to have at least one tubular section extending along the linear length of the support beam, the sheet of the support beam comprising a martensitic steel with a tensile strength of at least 980 MPa.

4. The vehicle floor assembly of claim 1, wherein the support beam comprises a sheet formed to have an open cross-sectional shape with at least one hat-shaped section that defines an upper wall portion, upright wall portions, and lower wall portions on opposing sides of the upper wall portion that interface with the floor panel.

5. The vehicle floor assembly of claim 4, wherein the lateral section of the floor panel includes a ridge formed in the metal sheet to protrude upward from a planar extent of the floor panel, and wherein one of the lower wall portions is welded to the ridge for the support beam and the floor panel to form the tubular shape that extends the linear length of the support beam.

6. The vehicle floor assembly of claim 1, wherein the lateral section of the floor panel includes a ridge formed in the metal sheet to protrude upward from a planar extent of the floor panel.

7. The vehicle floor assembly of claim 6, wherein the support beam comprises a metal sheet roll formed to have a pair of adjacent tubular members that are divided by the portion welded to the ridge of the floor panel.

8. The vehicle floor assembly of claim 7, wherein the pair of adjacent tubular members are disposed horizontally adjacent to each other when spanning across the floor panel.

9. The vehicle floor assembly of claim 7, wherein the portion of the support beam that is welded to the ridge arranges the pair of adjacent tubular members on opposing sides of the ridge.

10. The vehicle floor assembly of claim 1, wherein the support beam comprises a martensitic steel sheet with a tensile strength of at least 1,500 MPa.

11. A vehicle floor assembly comprising:
a floor panel comprising a metal sheet;
a pair of rocker members disposed longitudinally along sides of the floor panel; and
a crossmember coupled to and spanning between the pair of rocker members, the crossmember comprising a cross-sectional shape extending continuously along a length of the crossmember,
wherein the cross-sectional shape of the crossmember includes an upper wall portion and a lower wall portion each extending along the length of the crossmember,
wherein a bottom surface of the crossmember contacts an upper surface of the floor panel along the length and of the of the crossmember, and
wherein a weld is disposed at and extends through the lower wall portion to the metal sheet of the floor panel for attaching the crossmember to the floor panel.

12. The vehicle floor assembly of claim 11, wherein the crossmember comprises a sheet having a martensitic steel with a tensile strength of at least 980 MPa.

13. The vehicle floor assembly of claim 12, wherein the sheet of the crossmember is formed to have at least one tubular section extending along the length of the crossmember to carry a load path between the pair of rocker members.

14. The vehicle floor assembly of claim 12, wherein the sheet of the crossmember is formed to have an open cross-sectional shape with at least one hat-shaped section that defines the upper wall portion, upright wall portions, and lower wall portions on opposing sides of the upper wall portion, and wherein the lower wall portions interface with the floor panel.

15. The vehicle floor assembly of claim 14, wherein at least one of the lower wall portions is welded to the metal sheet of the floor panel for the crossmember and the floor panel to form a tubular shape that extends the length of the crossmember.

16. The vehicle floor assembly of claim 15, wherein the floor panel includes a ridge protruding upward from a planar extent of the floor panel, and wherein the lower wall portion is welded to the ridge.

17. The vehicle floor assembly of claim 12, wherein the floor panel includes a ridge protruding upward from a planar extent of the floor panel, wherein the crossmember comprises a pair of tubular members that are divided by the upper and lower wall portions, and wherein the lower wall portion is welded to the ridge to arrange the pair of tubular members on opposing sides of the ridge.

18. The vehicle floor assembly of claim 11, further comprising:
a second crossmember attached and spanning between the pair of rocker members at a longitudinally spaced distance from the first crossmember; and
a seat assembly coupled at and supported by the first and second crossmembers.

19. A vehicle floor assembly comprising:
a floor panel comprising a metal sheet;
a support beam disposed at and extending over an upper surface of the metal sheet, the support beam comprising a tubular beam having a cross-sectional shape extending continuously along a length of the tubular beam,
wherein the cross-sectional shape of the support beam includes an upper wall portion and a lower wall portion each extending along the tubular beam, and
wherein a weld is disposed at the upper wall portion and extends through the lower wall portion to the metal sheet of the floor panel and attaching the support beam to the floor panel.

20. The vehicle floor assembly of claim 19, wherein the metal sheet includes a ridge protruding upward from a planar extent of the floor panel, wherein the cross-sectional shape of the support beam includes the lower wall portion that is welded to the ridge of the metal sheet.
